(19) United States
(12) Patent Application Publication
(10) Pub. No.: US 2022/0007868 A1
(43) Pub. Date: Jan. 13, 2022

(54) NOVEL MULTI-MOUNT HANDSFREE BEVERAGE CONTAINER HOLDER SYSTEM WITH COUNTERWEIGHT/SUPPORT ELEMENT

(71) Applicant: Anthony James DeMatteo, Seattle, WA (US)

(72) Inventor: Anthony James DeMatteo, Seattle, WA (US)

(21) Appl. No.: 17/365,997

(22) Filed: Jul. 1, 2021

Related U.S. Application Data
(60) Provisional application No. 63/049,418, filed on Jul. 8, 2020.

(51) Int. Cl. A47G 23/02; B67B 7/16

(52) U.S. Cl. CPC A47G 23/02; A47G 2400/08; B67B 7/16

(57) ABSTRACT

The present invention comprises a novel multi-mount handsfree beverage container holder system consisting of an attached mounting system and storage slot for small personal items. The mounting system may consist of a fixed or non-fixed attachment configuration to the beverage container holder. The mounting system contains adequate space for storage of small personal items. The counterweight may comprise of enough size and weight to counterbalance the weight of a beverage container when placed in the mounting system. The counterweight may also contain one or more small apparatus of adequate size to be used for opening a beverage container and in some embodiments may be comprised of a flat shape. In other embodiments, the counter weight may be of a concave or convex shape.

### FIELD OF THE INVENTION

The present invention relates to the novel beverage container holding devices and mounting systems. More particularly, the invention relates to a multi-mount handsfree beverage container holder system with counterweight/support element.

### BACKGROUND

Beverage consumption has been an area of interest since the dawn of time. With this consumption has come the need to house said beverage in a contained area so as to prevent spillage or loss of beverage container.

Unfortunately there is not always a convenient or safe place to keep those beverage containers when not being held by the enjoyer of the previously mentioned beverage. Some people place their beverage on a table, counter, or ledge only to return to find their beverage missing or intermingled with other unknown beverages, lost forever.

In the recent past some beverage holders have been created where an individual may hang the beverage from their neck with a gimmicky tie, or pass their belt through a loop on the back of a koozie. They are configured for a finite amount of mounting positions, leaving the user stuck with their choice with no adaptability to their environment.

Therefore a need exists for a novel multi-mount handsfree beverage container holder system with counterweight/support element that could be mounted with no additional equipment. Freeing the user's peace of mind that their beverage is within reach and safe.

### BRIEF SUMMARY OF THE INVENTION

The present invention comprises a novel mounting element generally consisting of one or more removable counterweight/support elements which is capable of maintaining the weight of a beverage placed in the holder. Also attached to the mounting element is a cylindrical beverage container holder with an open top for receiving beverage containers of many different sizes, shapes, and material make up. The mounting element can easily be wedged into many different crevices, vertically, horizontally, or even in some cases upside-down and still support holding a beverage container.

### BRIEF DESCRIPTION OF DRAWINGS

Some embodiments of the present invention are illustrated as an example and are not limited by the figures of the accompanying drawings, in which like references may indicate similar elements and in which:

FIG. 1 depicts an exploded perspective view of one example of a multi-mount handsfree beverage container holder with counterweight/support element according to various embodiments of the present invention.

FIG. 2 depicts a side perspective view of one example of a multi-mount handsfree beverage container holder with counterweight/support element according to various embodiments described herein.

FIG. 3 depicts a top perspective view of one example of a multi-mount handsfree beverage container holder with counterweight/support element that has been deconstructed to show pattern shape, assembly, and material connections points according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New multi-mount handsfree beverage container holder system with counterweight/support elements are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

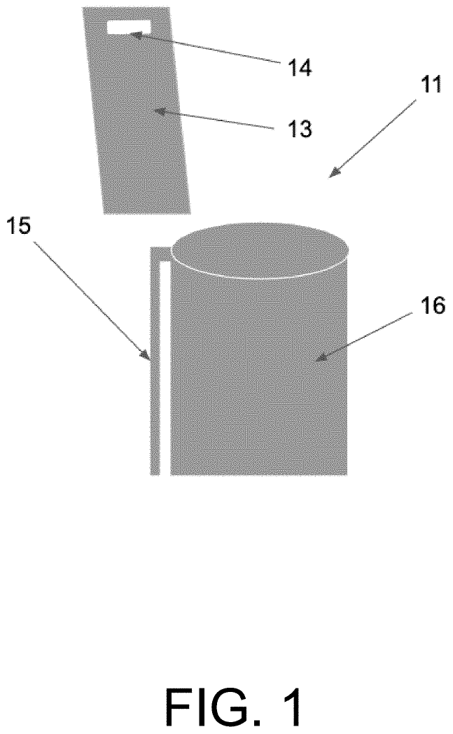

The present invention will now be described by referencing the appended figures representing preferred embodiments. FIG. 1 depicts an example of a multi-mount beverage holder system with counterweight/support element 11 according to various embodiments of the present invention. The multi-mount handsfree beverage container holder system with counterweight/support element 11 may contain a plurality of counterweight/support elements 13 (one element shown in FIG. 1) and in preferred embodiments can support a beverage container when mounted. In other embodiments, the multi-mount handsfree beverage container holder system with counterweight/support element 11 may comprise between one and four counterweight/support elements 13.

In preferred embodiments, the counterweight/support elements 13 may contain an apparatus for opening bottles 14. The counterweight/support element may be made of metal, plastic, or wood materials. The counterweight is secured in place by the mounting system 15 (sometimes called the counterweight holder) by means of a pocket-like sleeve and fixed to the beverage container holder 16. In other embodiments the mounting system may be detachable from the beverage holder.

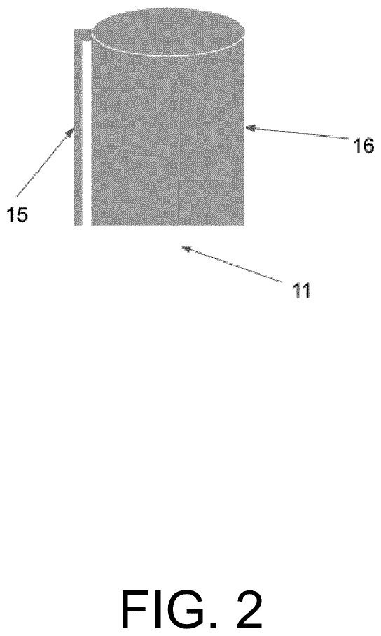

Referring now to FIG. 2 a side perspective view of an example of a multi-mount handsfree beverage container holder system with counterweight/support element according to the present invention. In this example, the counterweight/support element is not visible as it is inside the counterweight holder 15. In other embodiments, the counterweight holder 15 may also be used for storing small items such as, but not limited to personal identification cards, bank cards, or legal tender. The beverage container holder 16 in preferred embodiments, can support beverages of various sizes by way of the use of flexible material.

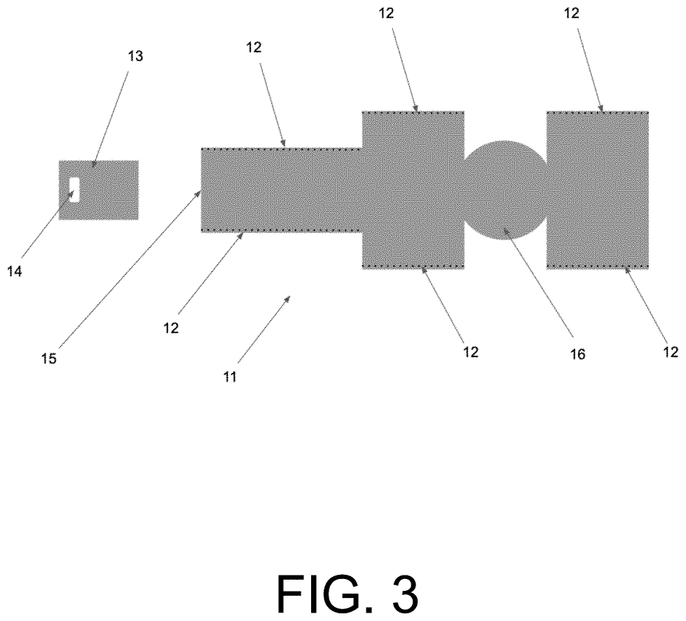

Perhaps best shown in FIG. 3, depicts a pattern shape, assembly, and various material connections points according to preferred embodiments. Assemblage of the mounting system 15 and the beverage container holder 16 are made through sewing thread along the seam line 12 to bond the opposing sides of the mounting system 15 and the beverage holder 16.

While preferred materials for elements have been described, the device is not limited by these materials. Wood, plastics, rubber, foam, metal alloys, aluminum, and other materials may comprise some or all of these elements of the multi-mount handsfree beverage container holder system with counterweight/support element and apparatuses in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A handsfree beverage container holder system comprising:
1. a beverage container holder;
2. an attached counterweight holder;
3. one or more counterweights.

2. A handsfree beverage container holder system of claim 1 further comprising a small storage slot.

3. A handsfree beverage container holder system of claim 1 or 2 further comprising a beverage opener.

4. A handsfree beverage container holder system of claim 1, 2, or 3 further comprising a detachable mounting system.
